(19) United States
(12) Patent Application Publication
(10) Pub. No.: US 2026/0195163 A1
(43) Pub. Date: Jul. 9, 2026

(54) METHODS FOR CONTROLLING LIVE MIGRATION OF VIRTUAL MACHINE, STORAGE MEDIUM AND COMPUTER DEVICE

(71) Applicant: CLOUD INTELLIGENCE ASSETS HOLDING (SINGAPORE) PRIVATE LIMITED, Singapore (SG)

(72) Inventor: Dianchen TIAN, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/129,725

(22) PCT Filed: Nov. 13, 2023
(86) PCT No.: PCT/CN2023/131313

§ 371 Date: May 14, 2025

(30) Foreign Application Priority Data
Nov. 14, 2022 (CN) 202211419964.0

(51) Int. Cl. G06F 9/455

(52) U.S. Cl. CPC G06F 9/45558; G06F 2009/4557

(57) ABSTRACT

Methods for controlling live migration of the virtual machine, a storage medium, and a computer device are provided. Several iterative migrations are first performed on the virtual machine during running of the virtual machine, and when the device states of the virtual machine are changed after each iterative migration, the changed device states are migrated by means of a next iterative migration, and migration duration of the next iterative migration is estimated. Only when the estimation result is less than a predetermined time threshold, the live migration is performed in a suspended state of the virtual machine; otherwise, the next iteration is performed on the virtual machine during the running of the virtual machine.

### CROSS REFERENCE TO RELATED APPLICATIONS

This disclosure is a National Stage of International Application PCT/CN2023/131313, filed on Nov. 13, 2023, which claims priority to Chinese Patent Application No. 202211419964.0, entitled “THERMAL MIGRATION CONTROL METHOD AND APPARATUS FOR VIRTUAL MACHINE, AND MEDIUM AND COMPUTER DEVICE”, filed with the China National Intellectual Property Administration (CNIPA) on Nov. 14, 2022, the entire contents of the above mentioned applications are incorporated herein by reference.

### TECHNICAL FIELD

The disclosure relates to the technical field of computers, in particular to a method and an apparatus for controlling live migration of a virtual machine, a medium and a computer device.

### BACKGROUND

When live migration is performed on a virtual machine, device states of the virtual machine need to be migrated from a source physical machine to a destination physical machine. In the related art, the live migration of the device state generally needs to be performed after the virtual machine is suspended. However, in some scenarios, there are a large amount of data about the device states, which results in a long downtime of the virtual machine during live migration.

### SUMMARY

According to a first aspect, an embodiment of the present disclosure provides a method for controlling live migration of a virtual machine, where the method is used for migrating device states of the virtual machine from a source physical machine to a destination physical machine; and the method includes: performing following steps cyclically, after an initial iterative migration is performed on at least part of migration data during running of the virtual machine: determining an amount of migration data for a next iterative migration; estimating a migration duration of the next iterative migration based on the amount of migration data for the next iterative migration and a migration bandwidth of a current iterative migration; in response to the migration duration being less than a predetermined time threshold, starting the next iterative migration after the virtual machine is controlled to be suspended, and completing the live migration of the virtual machine after the next iterative migration is successful; in response to the migration duration being greater than or equal to the time threshold, starting the next iterative migration during the running of the virtual machine, and returning to the determining the amount of migration data for the next iterative migration; where the migration data of each iterative migration include at least the device states of the virtual machine, and the migration data of the next iterative migration are determined based on device states changed after the current iterative migration.

According to a second aspect, an embodiment of the present disclosure provides a method for controlling live migration of a virtual machine, where the method is used for migrating device states and memory dirty pages of the virtual machine from a source physical machine to a destination physical machine, where both the source physical machine and the destination physical machine include an SOC chip and an RDMA device; and the method includes: controlling the SOC chip of the source physical machine to migrate the device states of the virtual machine to the SOC chip of the destination physical machine; and controlling the RDMA device of the source physical machine to migrate the memory dirty pages of the virtual machine to the RDMA device of the destination physical machine; where a migration process of the device states and a migration process of the memory dirty pages are performed in parallel.

According to a third aspect, an embodiment of the present disclosure provides a non-transitory computer-readable storage medium, having computer programs stored thereon, where the programs are executed by a processor to implement the method according to any one of the embodiments of the present disclosure.

According to a fourth aspect, an embodiment of the present disclosure provides a computer device, including a non-transitory storage, a processor, and computer programs stored in the non-transitory storage and executable on the processor, where the programs are executed by the processor to implement the method according to any one of the embodiments of the present disclosure.

It should be understood that the above general description and the following detailed description are only exemplary and explanatory, and do not limit the present disclosure.

### BRIEF DESCRIPTION OF DRAWINGS

In the drawings, like reference numerals refer to the same or similar components or elements throughout the several drawings unless otherwise specified. These figures are not necessarily drawn to scale. It should be understood that these drawings depict only some embodiments according to the present disclosure and should not be considered as limiting the scope of the present disclosure.

The accompanying drawings, which are incorporated in and constitute a part of the specification, illustrate embodiments consistent with the present disclosure and together with the specification serve to explain the technical solutions of the present disclosure.

FIG. 1 illustrates a schematic diagram of an application scenario according to an embodiment of the present disclosure.

FIG. 2 illustrates a flowchart of a method for controlling live migration of a virtual machine according to an embodiment of the present disclosure.

FIG. 3 illustrates a schematic diagram of a migration link between a source physical machine and a destination physical machine according to an embodiment of the present disclosure.

FIG. 4 illustrates a schematic diagram of a virtual memory according to an embodiment of the present disclosure.

FIG. 5 illustrates a schematic diagram of an architecture of a physical machine according to an embodiment of the present disclosure.

FIG. 6 illustrates a schematic diagram of a migration link between the source physical machine and the destination physical machine in the architecture of the physical machine of FIG. 5.

FIG. 7 illustrates a flowchart of a method for controlling live migration of a virtual machine according to another embodiment of the present disclosure.

FIG. 8 illustrates a block diagram of an apparatus for controlling live migration of a virtual machine according to an embodiment of the present disclosure.

FIG. 9 illustrates a block diagram of an apparatus for controlling live migration of a virtual machine according to another embodiment of the present disclosure.

FIG. 10 illustrates a schematic diagram of a computer device according to an embodiment of the present disclosure.

### DETAILED DESCRIPTION

Exemplary embodiments will be described in detail herein, examples of which are illustrated in the accompanying drawings. Where the following description refers to the drawings, unless otherwise indicated, like numerals in different drawings indicate the same or similar elements. The implementations described in the following exemplary embodiments do not represent all implementations consistent with the present disclosure. Rather, they are merely examples of apparatus and methods consistent with some aspects of the present disclosure, as detailed in the appended claims.

The terminologies used in this disclosure is for the purpose of describing particular embodiments only and is not intended to limit this disclosure. The singular forms “a”, “said”, and “the” used in this disclosure and the appended claims are also intended to include plural forms unless the context clearly indicates other meanings. It should also be understood that the term “and/or” as used herein refers to and encompasses any or all possible combinations of one or more associated listed items. In addition, the term “at least one” herein means any one of multiple options or any combination of at least two of the multiple options.

It should be understood that although the terms first, second, third, etc. may be used in the present disclosure to describe various information, these information should not be limited to these terms. These terms are only used to distinguish the same type of information from each other. For example, first information may also be referred to as second information without departing from the scope of the present disclosure, and similarly, the second information may also be referred to as the first information. Depending on context, the word “if” as used herein may be interpreted as “when” or “upon” or “in response to a determination”.

In order to make those skilled in the art better understand the technical solutions in the embodiments of the present disclosure, and make the above objects, features and advantages of the embodiments of the present disclosure more apparent and easy to understand, the technical solutions in the embodiments of the present disclosure will be further described in detail below with reference to the accompanying drawings.

FIG. 1 exemplarily shows an application scenario of an embodiment of the present disclosure. In this application scenario, a virtual machine 104 may be run on a source physical machine 102. In some cases (for example, the source physical machine 102 is shut down for maintenance), live migration is performed on the virtual machine so that various data (for example, device states of the virtual machine 104) required for running the virtual machine 104 is migrated from the source physical machine 102 to a destination physical machine 106 without interrupting services provided by the virtual machine 104. The live migration is a virtualization technology, and is used to move the virtual machine 104 from the source physical machine 102 to the destination physical machine 106 without shutting the virtual machine 104 down.

Because some of the device states of the virtual machine 104 may be changed during running of the virtual machine 104, to avoid inconsistency between the device states stored on the source physical machine 102 and the device states stored on the destination physical machine 106 after the live migration, the live migration of the virtual machine 104 is generally performed after the virtual machine 104 is suspended. However, in some scenarios, there are a large amount of data about the device states, which results in a long downtime of the virtual machine during live migration.

Based on this, embodiments of the present disclosure provide a method and apparatus for controlling live migration of the virtual machine 104, a medium, and a computer device. Several iterative migrations are first performed on the virtual machine 104 during the running of the virtual machine 104, and if the device states of the virtual machine 104 are changed after each iterative migration, the changed device states are migrated by means of a next iterative migration, and the migration duration of the next iterative migration is estimated. Only when the estimation result is less than a predetermined time threshold, the live migration is performed in a suspended state of the virtual machine 104; otherwise, the next iteration is performed on the virtual machine 104 during the running of the virtual machine 104. In this way, an amount of data that needs to be migrated in the suspended state of the virtual machine 104 is greatly reduced, thereby effectively reducing the downtime of the virtual machine 104 during the live migration. The solutions of the embodiments of the present disclosure are specifically described below with reference to the application scenario shown in FIG. 1.

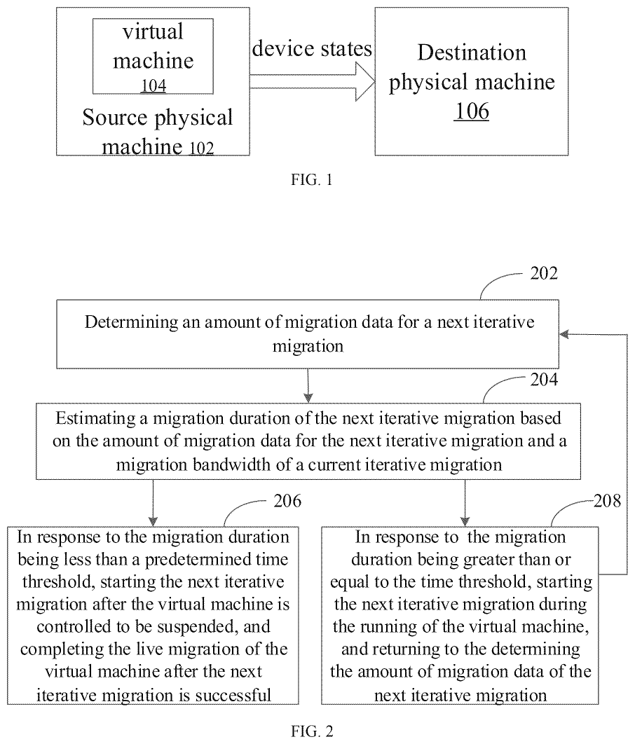

Referring to FIG. 2, an embodiment of the present disclosure provides a method for controlling live migration of a virtual machine 104, which is used for migrating device states of the virtual machine 104 from a source physical machine 102 where the virtual machine 104 is located to a destination physical machine 106. The method includes: performing following steps cyclically, after an initial iterative migration is performed on at least part of migration data during the running of the virtual machine 104. At step 202, an amount of migration data for next iterative migration is determined; at step 204, a migration duration of the next iterative migration is estimated based on the amount of migration data for the next iterative migration and a migration bandwidth of a current iterative migration; at step 206, when the migration duration is less than a predetermined time threshold, the next iterative migration is started after the virtual machine 104 is controlled to be suspended, and the live migration of the virtual machine is completed after the next iterative migration is successful; and at step 208, when the migration duration is greater than or equal to the time threshold, the next iterative migration is started during the running of the virtual machine 104, and step 202 is returned.

Step 202 to step 208 of the embodiment of the present disclosure may be performed cyclically after performing the initial iterative migration on at least part of the migration data during the running of the virtual machine 104. The initial iterative migration is the first iterative migration of the virtual machine 104. The migration data of each iterative migration include at least device states of the virtual machine. In an implementation, the full device states of the virtual machine 104 may be used as the migration data in the initial iterative migration, and migrated from the source physical machine 102 to the destination physical machine 106. And the embodiments of the present disclosure are not limited thereto, and only a part of the device states of the virtual machine 104 may be used as the migration data and migrated during the initial iterative migration.

In step 202, the amount of migration data for the next iterative migration may be determined. In the case that the current (i.e., the latest) iterative migration is the initial iterative migration, the next iterative migration is the 2nd iterative migration; in the case that the current iterative migration is the 2nd iterative migration, the next iterative migration is the 3rd iterative migration; . . . ; and so on. Without loss of generality, the next iterative migration is denoted as the (i+1)-th iterative migration, and the current iterative migration is denoted as the i-th iterative migration, where i is a positive integer.

In some embodiments, the migration data of the next iterative migration may be determined based on the device states changed after the current iterative migration. For example, assuming that the device states migrated during the i-th iterative migration include {S0, S1, . . . , Sn}(n is a positive integer), and after the i-th iterative migration, {Sk1, Sk2, . . . , Skm} (k1, k2, . . . , km are all positive integers, and km≤n) are changed, {Sk1, Sk2, . . . , Skm} may be used as the migration data for the (i+1)-th iterative migration, and the data volume of {Sk1, Sk2, . . . , Skm} is the amount of the migration data for the (i+1)-th iterative migration.

In step 204, the migration duration of the (i+1)-th iterative migration may be estimated based on the amount of migration data for the (i+1)-th iterative migration obtained in step 202 and the migration bandwidth of the i-th iterative migration. Where the migration bandwidth of the i-th iterative migration may be determined based on the amount of migration data for the i-th iterative migration and the migration duration of the i-th iterative migration. When the i-th iterative migration is the initial iterative migration, and the full device states are migrated during the initial iterative migration, the amount of migration data for the i-th iterative migration is the total data volume of the full device states. When the i-th iterative migration is not the initial iterative migration, the amount of migration data of the i-th iterative migration is the data volume of the device states changed after the (i−1)-th iterative migration. Assuming that the amount of migration data for the i-th iterative migration is denoted as Rᵢ, and the migration duration of the i-th iterative migration is denoted as tᵢ, the migration bandwidth Bᵢ of the i-th iterative migration may be denoted as:

$${B}_{i} = {R}_{i} / {t}_{i} \qquad ( 1 )$$

Therefore, the estimation result of the migration duration for the (i+1)-th iterative migration may be denoted as:

$${\tilde{t}}_{i + 1} = {R}_{i + 1} / {B}_{i} \qquad ( 2 )$$

Where Rᵢ₊₁ is the amount of migration data for the (i+1)-th iterative migration; \tilde{t}ᵢ₊₁ is the estimation result of the migration duration for the (i+1)-th iterative migration.

The estimation result obtained in step 204 may be used to determine whether the (i+1)-th iterative migration can be performed when the virtual machine 104 is in a suspended state. If the estimation result is relatively small, it indicates that the time consumed for the (i+1)-th iterative migration is relatively short, and even if the (i+1)-th iterative migration is performed when the virtual machine 104 is in the suspended state, the virtual machine 104 will not be in the suspended state for a long time, therefore, the (i+1)-th iterative migration can be performed when the virtual machine 104 is in the suspended state. Otherwise, it indicates that the time consumed for the (i+1)-th iterative migration is relatively long, and if the (i+1)-th iterative migration is performed when the virtual machine 104 is in the suspended state, the virtual machine 104 will be in the suspended state for a long time, therefore, the (i+1)-th iterative migration needs to be performed during the running of the virtual machine.

In some embodiments, the estimation result obtained in step 204 may be compared with a predetermined time threshold; where the time threshold may be determined based on service demands of services running on the virtual machine 104. Different time thresholds may be set for different types of services. One of step 206 and step 208 may be selectively performed based on the comparison result.

In step 206, when the estimated migration duration is less than the predetermined time threshold, it indicates that the migration duration of the (i+1)-th iterative migration is relatively small, and at this time, the virtual machine 104 may be controlled to enter the suspended state, and then the (i+1)-th iterative migration is started when the virtual machine 104 is in the suspended state. After the (i+1)-th iterative migration is completed, the live migration of the virtual machine 104 is completed. In this embodiment, when the virtual machine 104 is in the suspended state, a final iterative migration may be performed, so that all device states changed after the last iterative migration are migrated to the destination physical machine 106.

In step 208, when the estimated migration duration is greater than or equal to the time threshold, it indicates that the migration duration of the (i+1)-th iterative migration is relatively long, at this time, the next iterative migration may be started during the running of the virtual machine 104, and step 202 is returned.

In some embodiments, for each iterative migration, after the iterative migration starts, a start time of the iterative migration may be obtained; device states changed after the start time are marked; and the marked device states are determined as the device states changed after the iterative migration. Assuming that the start time of the i-th iterative migration is denoted as Tᵢ₁, the device states changed after Tᵢ₁ may be marked, and the marked device states are determined as the device states changed after the i-th iterative migration. In an embodiment, for each iterative migration, after the iterative migration ends, an end time of the iterative migration may also be obtained, so that the device states changed between the start time of the iterative migration and the end time of the iterative migration may be determined as the device states changed after the iterative migration. Assuming that the end time of the i-th iterative migration is denoted as Tᵢ₂, the device states changed between Tᵢ₁ and Tᵢ₂ may be marked, and the marked device states are determined as the device states changed after the i-th iterative migration.

When the device states are marked, a tag may be provided for a storage address of each device state, to indicate whether the device state at the storage address is changed after the iterative migration. For example, if a tag corresponding to a storage address is 1 after the i-th iterative migration, it indicates that the device state at the storage address is changed after the i-th iterative migration; or if a tag corresponding to a storage address is 0 after the i-th iterative migration, it indicates that the device state at the storage address is not changed after the i-th iterative migration.

For each iterative migration, storage addresses of the device states to be migrated in the source physical machine 102 during the current iterative migration may be sent to the destination physical machine 106 by the source physical machine 102, so that the device states to be migrated in the current iterative migration are pulled from the source physical machine 102 by the destination physical machine 106. Alternatively, the storage addresses of the device states to be migrated in the destination physical machine 106 during the current iterative migration may be sent to the source physical machine 102 by the destination physical machine 106, so that the device states to be migrated in the current iterative migration are written into the storage addresses in the destination physical machine 106 by the source physical machine 102. In some embodiments, both the source physical machine 102 and the destination physical machine 106 may include a Remote Direct Memory Access (RDMA) device. The device states may be pulled from the source physical machine 102 by the RDMA device of the destination physical machine 106, or the device states may be written into the destination physical machine 106 by the RDMA device of the source physical machine 102.

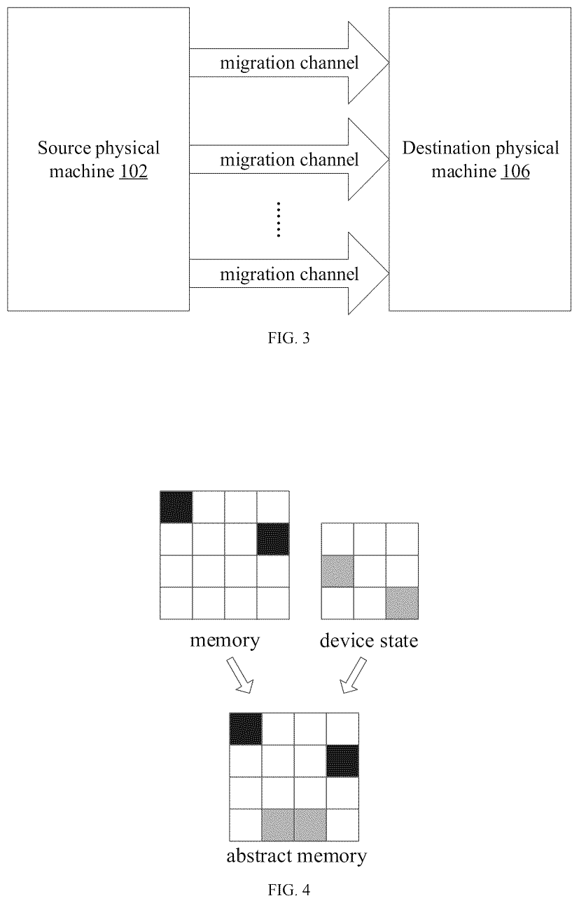

In addition to migrating the device states, other data of the virtual machine 104 may be migrated from the source physical machine 102 to the destination physical machine 106 during the live migration of the virtual machine 104. The other data include, but are not limited to, memory dirty pages of the virtual machine 104. That is, in addition to the device states of the virtual machine 104, the migration data may further include the memory dirty pages of the virtual machine 104. Referring to FIG. 3, in some embodiments, a plurality of migration channels may be included between the source physical machine 102 and the destination physical machine 106, and different migration channels are configured for iterative migration performed on different migration data in the virtual machine 104. The plurality of migration channels include a migration channel (referred to as a first migration channel) configured to migrate the device states of the virtual machine 104. In an embodiment in which the data to be migrated includes the memory dirty pages of the virtual machine 104, the plurality of migration channels further include a migration channel (referred to as a second migration channel) configured to migrate the memory dirty pages of the virtual machine 104. In an embodiment in which the data to be migrated includes data other than the device states and the memory dirty pages, the plurality of migration channels further include channels other than the first migration channel and the second migration channel, which are not listed one by one herein.

In an embodiment that include a plurality of migration channels, there are a plurality of iterative processes that are performed simultaneously. Generally, in the related art, the downtime of the virtual machine 104 can be controlled only during the migration for the memory dirty pages, and the downtime of the virtual machine 104 cannot be controlled during the migration for the device states, thereby causing a problem that the downtime of the virtual machine 104 is uncontrollable during the migration for the device states. In order to solve the problem, embodiments of the present disclosure provide a solution for abstracting and fusing the downtime, wherein downtimes of a plurality of iterative processes are controlled by using one computation logic. Referring to FIG. 4, in an embodiment of the present disclosure, an abstract memory is introduced. The abstract memory is used to represent the total amount of data that needs to be iteratively migrated in the virtual machine. A change increment of the abstract memory in each iteration is the sum of increments of all data that needs to be iteratively migrated in each iteration, that is, each type of data changed after the iterative migration is abstracted as a change to the abstract memory. For example, in FIG. 4, the black squares represent the amount of change for the memory, and the grey squares represent the amount of change for the device states, and both kinds of changes can be unified as the amount of change for the abstract memory.

Therefore, during the live migration, an iterative framework may traverse all various migration data that need to be iterated, calculate a sum of changes, and use an average migration bandwidth of all migration data during the same iterative migration as a migration bandwidth of this iterative migration, so that the downtimes of a plurality of iterative processes may be calculated by a unified downtime calculation manner, to accurately control downtimes of the virtual machines 104 during the live migration for various data. The specific manner for calculating the downtime will be described below.

When a plurality of migration channels are included, the migration data of the next iterative migration include migration data which have been changed of each migration channel after the current iterative migration; and the migration bandwidth of the current iterative migration is the average migration bandwidth of each migration channel during the current iterative migration. Taking the number of migration channels as v as an example, the migration data of the (i+1)-th iterative migration include migration data of the first migration channel changed after the i-th iterative migration, migration data of the second migration channel changed after the i-th iterative migration, . . . , and migration data of the v-th migration channel changed after the i-th iterative migration. Assuming that the amount of migration data of the j-th migration channel changed after the i-th iterative migration is Rᵢⱼ (1≤j≤v), the total amount R_{i,total} of migration data changed after the i-th iterative migration is:

$${R}_{i , total} = {\sum }_{j = 1}^{v} {R}_{ij} \qquad ( 3 )$$

Assuming that a total migration duration of the i-th iterative migration is t_{i,total}, the average migration bandwidth B_{i,avg} of each migration channel during the i-th iterative migration may be denoted as:

$${B}_{i , avg} = {R}_{i , total} / {t}_{i , total} \qquad ( 4 )$$

Where during each iterative migration, the migration data of each migration channel may be migrated in parallel, or may be migrated in series. Embodiments of parallel migration and serial migration are described below.

When the migration data of each migration channel is migrated in parallel, the total migration duration of the i-th iterative migration is the largest one of durations of performing the i-th iterative migration on the migration data of all channels. Assuming that the migration duration of the migration data of the j-th migration channel during the i-th iterative migration is denoted as tᵢⱼ, the total migration duration of the i-th iterative migration may be denoted as:

$${t}_{i , total} = max {t}_{ij} \qquad ( 5 )$$

When the migration data of each migration channel is migrated in series, the total migration duration of the i-th iterative migration is the sum of durations of performing the i-th iterative migration on the migration data of all channels. Assuming that the migration duration of the migration data of the j-th migration channel during the i-th iterative migration is denoted as tᵢⱼ, the total migration duration of the i-th iterative migration may be denoted as:

$${t}_{i , total} = {\sum }_{j = 1}^{v} {t}_{ij} \qquad ( 6 )$$

The above t_{i,total} is the estimation result of downtime when there are multiple migration channels. When t_{i,total} is less than the predetermined time threshold, the next iterative migrations in each migration channel may be started after the virtual machine 104 is controlled to be suspended, and the live migration of the virtual machine 104 is completed after the next iterative migrations are successful; and when t_{i,total} is greater than or equal to the predetermined time threshold, the next iterative migrations in each migration channel may be started during the running of the virtual machine 104, and step 202 is returned.

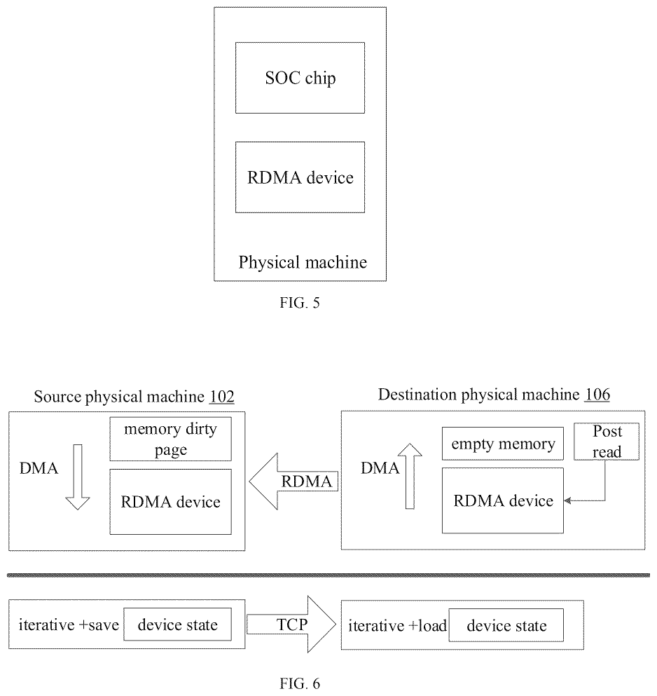

Taking the plurality of migration channels including the first migration channel and the second migration channel as an example, in some embodiments, referring to FIG. 5, both the source physical machine 102 and the destination physical machine 106 include a System on Chip (SOC) Chip and an RDMA device. The first migration channel indicates a migration channel between the SOC chip of the source physical machine 102 and the SOC chip of the destination physical machine 106, and the second migration channel indicates a migration channel between the RDMA device of the source physical machine 102 and the RDMA device of the destination physical machine 106. The physical machine shown in FIG. 5 may be the source physical machine 102 or the destination physical machine 106.

In this case, referring to FIG. 6, during iterative migration, the SOC chip of the source physical machine 102 may be controlled to issue the device states to be migrated during each iterative migration to the SOC chip of the destination physical machine 106 through the first migration channel; or the SOC chip of the source physical machine 102 may be controlled to send the first storage address of the memory dirty page to be migrated in the source physical machine 102 during each iterative migration to the SOC chip of the destination physical machine 106, so that the memory dirty page stored in the first storage address is pulled by the RDMA device of the destination physical machine 106 through the second migration channel.

When migrating the device states, the device states in the source physical machine 102 are saved firstly by the SOC chip of the source physical machine 102. Then the saved device states are transmitted to the SOC chip of the destination physical machine 106 through the first migration channel. The received device states are loaded to the destination physical machine 106 by the SOC chip of the destination physical machine 106. Save, transmission, and load of the same migration channel are performed in series, and save, transmission, and load of different migration channels may be performed in series or in parallel.

When migrating the memory dirty pages, for the initial iterative migration, if the device states migrated during the initial iterative migration are the full device states, the first storage address includes storage addresses of the full device states of the virtual machine. In some embodiments, the storage addresses may be issued through the first migration channel, and the SOC chip of the source physical machine 102 and the SOC chip of the destination physical machine 106 may communicate by using a TCP protocol, to transmit the device states and the first storage address. Starting from the second iterative migration, the first storage address includes storage addresses of the device states changed after the last iterative migration.

After issuing the first storage address to the SOC chip of the destination physical machine 106, an RDMA read request may be generated by the destination physical machine 106 based on the first storage address. And the RDMA read request carrying the first storage address is sent to the RDMA device of the source physical machine 102 by the destination physical machine 106. The RDMA device of the source physical machine 102 may read, based on the first storage address carried in the RDMA read request, the memory dirty pages to be migrated from the source physical machine 102 in a DMA manner, and issue, the memory dirty pages read by the RDMA device of the source physical machine 102 to the RDMA device of the destination physical machine 106 through the second migration channel. Then, the RDMA device of the destination physical machine 106 may store the received memory dirty pages to the second storage address of the destination physical machine 106 in the DMA manner.

Alternatively, during the iterative migration, the SOC chip of the source physical machine 102 may be controlled to issue, through the first migration channel, the device states to be migrated during each iterative migration to the SOC chip of the destination physical machine 106. After the second storage address sent by the SOC chip of the destination physical machine 106 is received by the SOC chip of the source physical machine 102, the RDMA device of the source physical machine 102 may be controlled to write, through the second migration channel, the memory dirty pages to be migrated during each iterative migration into the second storage address.

For an embodiment of migrating the device states, refer to the foregoing embodiments, and details are not repeatedly described herein. When the memory dirty pages are migrated, the SOC chip of the destination physical machine 106 may send the second storage address used to store the memory dirty pages in the destination physical machine 106 to the SOC chip of the source physical machine 102 through the first migration channel. After receiving the second storage address, the SOC chip of the source physical machine 102 may read the memory dirty pages to be migrated from the source physical machine 102 in a DMA manner, may further generate an RDMA write request that carries the memory dirty pages to be migrated and the second storage address, and send the RDMA write request to the RDMA device of the destination physical machine 106. After receiving the RDMA write request, the RDMA device of the destination physical machine 106 may write the memory dirty pages to be migrated carried in the RDMA write request into the second storage address in the DMA manner.

In the above embodiment, the migration channel (that is, the second migration channel) between the RDMA devices is used to migrate the memory dirty pages, so that in a process of migrating the memory dirty pages, the migration channel (that is, the first migration channel) between the SOC chips is in an idle state, therefore, the device states can be migrated in parallel by using a network transmission capability between the SOC chips during the process of migrating the memory dirty pages. For example, in an embodiment in which the memory dirty pages are pulled by the RDMA device of the destination physical machine 106, because the memory dirty pages are actively pulled by the RDMA device of the destination physical machine 106, the source physical machine 102 does not need to be busy interacting with the RDMA device of the destination physical machine 106, so that better performance can be obtained. This architecture for pulling memory dirty pages by using the RDMA device is referred to as a post read architecture.

In the above embodiments, although the iterative migrations may be performed in the first migration channel and the second migration channel in parallel, in actual application, the iterative migrations may also be performed in the first migration channel and the second migration channel in series. When the iterative migrations in each migration channel are performed in parallel, the total migration duration of each migration channel during the i-th iterative migration is determined based on the maximum value of the migration durations of each migration channel during the i-th iterative migration. When the iterative migrations in each migration channel are performed in series, the total migration duration of each migration channel during the i-th iterative migration is determined based on the sum of the migration durations of each migration channel during the i-th iterative migration. For a manner of determining the total migration duration, refer to the foregoing formula (5) and formula (6), and details are not repeatedly described herein.

When the service running in the virtual machine is in a valley period, generally, as the number of iterations increases gradually, the amount of migration data during each iterative migration decreases gradually (i.e. the migration duration of the iterative migration is inversely correlated to the number of iterations of the iterative migration), so that the live migration of the virtual machine 104 can be implemented by using the cyclic steps in the above embodiments. However, during a peak period of the service, the device states generally are changed frequently, which causes the amount of migration data of each iterative migration to fluctuate up and down, thereby causing a condition that the migration duration estimated in step 206 is less than the predetermined time threshold is always difficult to be satisfied. In this case, the live migration needs to be terminated to prevent the live migration from entering a dead cycle. In some embodiments, migration durations of a plurality of iterative migrations may be obtained; and it is determined whether a termination condition for the live migration is satisfied based on the migration durations of the plurality of iterative migrations.

In some embodiments, a change trend of the migration durations of the plurality of iterative migrations may be determined based on the migration durations of the plurality of iterative migrations, and it is determined whether the termination condition for the live migration is satisfied based on the change trend. When the change trend satisfies the inverse correlation between the migration durations of the plurality of iterative migrations and the number of iterations of the iterative migrations, it may be determined that the termination condition for the live migration is not satisfied; otherwise, it may be determined that the termination condition for the live migration is satisfied.

In some other embodiments, the number of iterative migrations with the migration durations greater than or equal to the time threshold may be obtained. When the number of continuous iterative migrations whose migration durations are greater than or equal to the time threshold reaches a predetermined number threshold, it may be determined that the termination condition for the live migration is satisfied. When the migration duration corresponding to any iterative migration before the number of iterative migrations reaches the predetermined number threshold is less than the predetermined time threshold, it may be determined that the termination condition for the live migration is not satisfied.

In still other embodiments, it may be determined whether there is an iterative migration whose migration duration is less than the time threshold within a predetermined time period. When the migration durations of each iterative migration in the plurality of iterative migrations within a predetermined time period are all greater than or equal to the time threshold, it may be determined that the termination condition for the live migration is satisfied. When the migration duration of any iterative migration in the plurality of iterative migrations within the predetermined time period is less than the time threshold, it may be determined that the termination condition for the live migration is not satisfied.

In other embodiments, it may also be determined whether the termination condition for the live migration is satisfied according to other conditions, which is not listed one by one herein.

In some embodiments, when determining that the termination condition for the live migration is satisfied, the iterative migration is terminated. In some other embodiments, after the iterative migration is terminated, the live migration may also be re-attempted under triggering of a predetermined condition, and for a manner of re-attempting the live migration, refer to the above embodiments, and details are not repeatedly described herein. Where the predetermined condition may be that a predetermined time interval is reached, or a live migration instruction issued manually is received, or running performance of the source physical machine 102 is satisfied with a predetermined performance requirement.

The embodiments of the present disclosure have the following advantages: (1) By performing a plurality of iterative migrations during the running of the virtual machine 104, the migration of most of the device states is completed before the virtual machine 104 is suspended, and there are fewer device states that need to be migrated after the virtual machine 104 is suspended, thereby achieving the effect of reducing the downtime during the live migration. (2) The migration of the device states can be performed concurrently with the migration of the memory dirty pages, and the time taken to migrate the device states in the downtime can be controlled, so that the downtime of the device states can be controllable by an accurate calculation when mass device states are migrated.

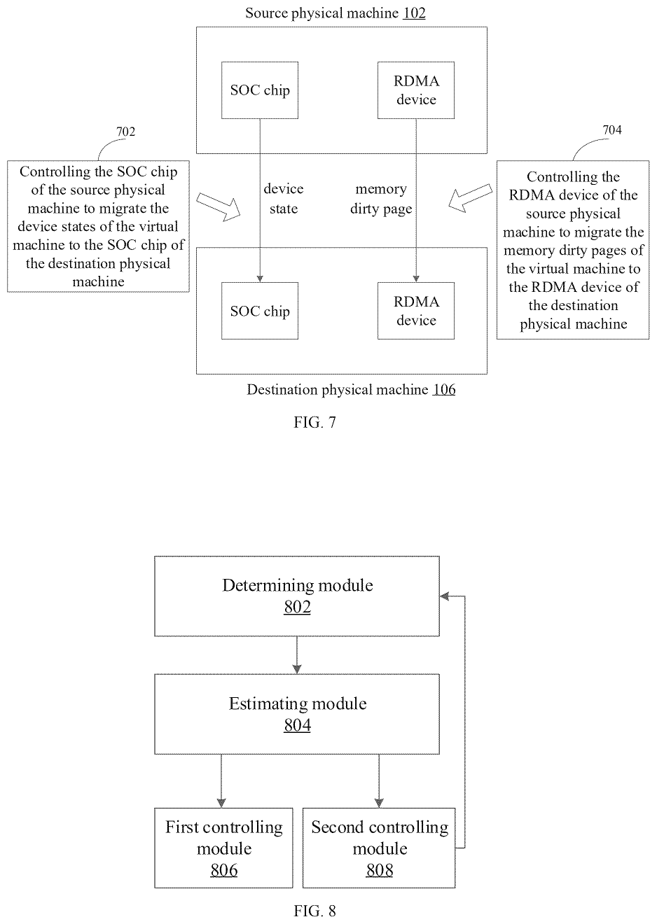

Referring to FIG. 7, an embodiment of the present disclosure further provides a method for controlling live migration of a virtual machine 104, which is used for migrating device states and memory dirty pages of the virtual machine 104 from a source physical machine 102 to a destination physical machine 106, where both the source physical machine 102 and the destination physical machine 106 include an SOC chip and an RDMA device; and the method includes: step 702, controlling the SOC chip of the source physical machine 102 to migrate the device states of the virtual machine 104 to the SOC chip of the destination physical machine 106; and step 704, controlling the RDMA device of the source physical machine 102 to migrate the memory dirty pages of the virtual machine 104 to the RDMA device of the destination physical machine 106, where a migration process of the device states and a migration process of the memory dirty pages are performed in parallel.

In some embodiments, the controlling the RDMA device of the source physical machine to migrate the memory dirty pages of the virtual machine to the RDMA device of the destination physical machine includes: controlling the SOC chip of the source physical machine to send a first storage address of the memory dirty pages of the virtual machine in the source physical machine to the SOC chip of the destination physical machine; and in response to the RDMA device of the source physical machine receiving an RDMA read request sent by the RDMA device of the destination physical machine, controlling the RDMA device of the source physical machine to read the memory dirty pages of the virtual machine from the first storage address carried in the RDMA read request and return the memory dirty pages to the RDMA device of the destination physical machine.

In some embodiments, the controlling the RDMA device of the source physical machine to migrate the memory dirty pages of the virtual machine to the RDMA device of the destination physical machine includes: after the SOC chip of the source physical machine receives a second storage address sent by the SOC chip of the destination physical machine, controlling the RDMA device of the source physical machine to send an RDMA write request carrying the second storage address to the RDMA device of the destination physical machine, to write the memory dirty pages of the virtual machine to the second storage address.

The device states and the memory dirty pages in the embodiments of the present disclosure may be migrated from the source physical machine 102 to the destination physical machine 106 through multiple iterative migrations, or may be migrated in other manners, for example, may be migrated in a suspended state of the virtual machine 104. In the embodiments in which the iterative migration is performed, details of the method in the embodiments of the present disclosure may be found in the above method embodiments, and details are not described herein again.

A person skilled in the art may understand that, in the above methods of a specific implementation, a drafting sequence of each step does not mean a strict execution sequence to constitute any limitation on an implementation process, and a specific execution sequence of each step should be determined based on functions and possible internal logic of the steps.

According to the embodiments of the present disclosure, several iterative migrations are first performed on the migration data including device states of the virtual machine during the running of the virtual machine; if the device states of the virtual machine are changed after each iterative migration, the changed device states are migrated by means of the next iterative migration, and the migration duration of the next iterative migration is estimated. Only when the estimated migration duration is less than the predetermined time threshold, the live migration is performed in the suspended state of the virtual machine; otherwise, the next iteration is performed on the virtual machine during the running of the virtual machine. In this way, the amount of data that needs to be migrated in the suspended state of the virtual machine is greatly reduced, thereby effectively reducing the downtime of the virtual machine during the live migration.

Referring to FIG. 8, an embodiment of the present disclosure further provides an apparatus for controlling live migration of a virtual machine, where device states of the virtual machine are migrated from a source physical machine to a destination physical machine through a plurality of iterative migrations, and the apparatus includes: a determining module 802, configured to determine an amount of migration data for a next iterative migration; an estimating module 804, configured to estimate a migration duration of the next iterative migration based on the amount of migration data for the next iterative migration and a migration bandwidth of a current iterative migration; a first controlling module 806, configured to, in response to the migration duration being less than a predetermined time threshold, start the next iterative migration after the virtual machine is controlled to be suspended, to complete the live migration of the virtual machine; and a second controlling module 808, configured to, in response to the migration duration being greater than or equal to the time threshold, start the next iterative migration during running of the virtual machine, and return to execute a function of the determining module; where the migration data of each iterative migration include at least the device states of the virtual machine; the migration data of the next iterative migration are determined based on device states changed after the current iterative migration; and functions of the determining module 802, the estimating module 804, the first controlling module 806, and the second controlling module 808 are executed cyclically after an initial iterative migration is performed on at least part of the migration data during the running of the virtual machine.

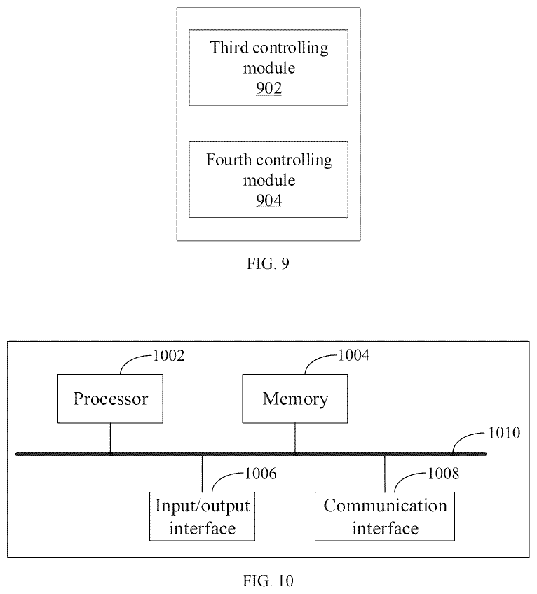

Referring to FIG. 9, an embodiment of the present disclosure further provides another apparatus for controlling live migration of a virtual machine, configured to migrate device states and memory dirty pages of the virtual machine from a source physical machine to a destination physical machine, where both the source physical machine and the destination physical machine include an SOC chip and an RDMA device; the apparatus includes: a third controlling module 902, configured to control the SOC chip of the source physical machine to migrate the device states of the virtual machine to the SOC chip of the destination physical machine; and a fourth controlling module 904, configured to control the RDMA device of the source physical machine to migrate the memory dirty pages of the virtual machine to the RDMA device of the destination physical machine, where a migration process of the device states and a migration process of the memory dirty pages are performed in parallel.

An embodiment of the present disclosure further provides a computer device, including at least a storage, a processor, and computer programs stored in the storage and executable on the processor, where the programs are executed by the processor to implement the method according to any one of the above embodiments.

FIG. 10 is a schematic diagram illustrating a more specific hardware structure of a computing device according to an embodiment of the present disclosure; and the device may include a processor 1002, a storage 1004, an input/output interface 1006, a communication interface 1008, and a bus 1010. Where the processor 1002, the storage 1004, the input/output interface 1006, and the communication interface 1008 are in communication connection with each other inside the device by the bus 1010.

The processor 1002 may be implemented by using a general-purpose Central Processing Unit (CPU), a microprocessor, an Application Specific Integrated Circuit (ASIC), one or more integrated circuits, or the like, and is configured to execute related programs, to implement the technical solutions provided in the embodiments of the present disclosure. The processor 1002 may further include a graphics card, and the graphics card may be a Nvidia titan X graphics card or a 1080 Ti graphics card, or the like.

The memory 1004 may be implemented in a form of a Read Only Memory (ROM), a Random Access Memory (RAM), a static storage device, a dynamic storage device, or the like. The memory 1004 may store an operating system and other application programs, and when the technical solutions provided in the embodiments of the present disclosure are implemented by a software or a firmware, related program codes are stored in the memory 1004 and invoked and executed by the processor 1002.

The input/output interface 1006 is configured to connect to an input/output module to input and output information. The input/output module may be configured as a component in the device (not shown in the figure), or may be externally connected to the device to provide corresponding functions. Where the input device may include a keyboard, a mouse, a touch screen, a microphone, various sensors, etc., and the output device may include a display, a speaker, a vibrator, an indicator light, etc.

The communication interface 1008 is configured to connect to a communication module (not shown in the figure), to implement communication interaction between the device and other devices. The communication module may implement communication in a wired manner (e.g., USB, network cable, etc.), or may implement communication in a wireless manner (e.g., mobile network, WIFI, Bluetooth, etc.).

The bus 1010 includes a path to transfer information between various components (such as the processor 1002, the memory 1004, the input/output interface 1006, and the communication interface 1008) of the device.

It should be noted that although the above device only shows the processor 1002, the memory 1004, the input/output interface 1006, the communication interface 1008, and the bus 1010, in a specific implementation process, the device may further include other components necessary for implementing normal operation. In addition, a person skilled in the art may understand that the above device may include only components necessary for implementing the solutions in the embodiments of the present disclosure, and does not need to include all components shown in the figures.

An embodiment of the present disclosure further provides a physical machine, including: an SOC chip, configured to communicate with SOC chips of other physical machines to migrate device states of a virtual machine between the local machine and the other physical machines; an RDMA device, configured to communicate with RDMA devices of the other physical machines to migrate memory dirty pages of the virtual machine between the local machine and the other physical machines; and a control unit, configured to control the SOC chip of the local machine and the RDMA device of the local machine, so that the device states and the memory dirty pages are migrated in parallel.

For a specific architecture of the physical machine and a specific method for live migration in the embodiments of the present disclosure, reference may be made to FIG. 5 and the above method embodiments, and details are not described herein again. The physical machine in the embodiment of the present disclosure may be the source physical machine 102 or the destination physical machine 106. In the case that the physical machine in the embodiment of the present disclosure is the source physical machine 102, the device states and the memory dirty pages are migrated from the local machine to the other physical machines through the live migration; in the case that the physical machine in the embodiment of the present disclosure is the destination physical machine 106, the device states and the memory dirty pages are migrated from the other physical machines to the local machine through the live migration.

An embodiment of the present disclosure further provides a non-transitory computer-readable storage medium, having computer programs stored thereon, where the programs are executed by a processor to implement the method according to any one of the above embodiments.

The non-transitory computer-readable medium include permanent and non-permanent, removable and non-removable media that can be used to store information in any method or technology. The information may be computer-readable instructions, data structures, modules of programs, or other data. Examples of non-transitory storage medium for a computer include, but are not limited to, Phase Change Random Access Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory or other memory technology, Compact Disc Read-Only Memory (CD-ROM), Digital Versatile Disks (DVD) or other optical storage, magnetic cassettes, magnetic tape magnetic disk storage or other magnetic storage devices, or any other non-transitory non-transmission medium that can be used to store information that may be accessed by a computing device. As defined herein, the non-transitory computer-readable medium do not include transitory media, such as modulated data signals and carrier waves.

It can be seen from the description of the above embodiments that those skilled in the art can clearly understand that the embodiments of the present specification can be implemented by means of software and a necessary universal hardware platform. Based on such understanding, the technical solutions of the embodiments of the present specification essentially or the part contributing to the conventional art may be embodied in the form of a software product; and the computer software product may be stored in a non-transitory storage medium, such as ROM/RAM, magnetic disk, optical disk, and includes several instructions for enabling a computer device (which may be a personal computer, a server, or a network device, etc.) to execute the methods described in each embodiment or some parts of the embodiments of the present specification.

The system, appliance, module or unit illustrated in the above embodiments may be specifically implemented by a computer device or an entity, or implemented by a product having a certain function. A typical implementation device is a computer, and a specific form of the computer may be a personal computer, a laptop computer, a cellular phone, a camera phone, a smartphone, a personal digital assistant, a media player, a navigation device, an email transceiver device, a game console, a tablet computer, a wearable device, or a combination of any of these devices.

The embodiments in this specification are described in a progressive manner, the same and similar parts between the embodiments may refer to each other, and each embodiment focuses on differences from other embodiments. In particular, for the apparatus embodiment, since it is substantially similar to the method embodiment, the description is relatively simple, and reference may be made to some descriptions of the method embodiment for related parts.

The apparatus embodiments described above are merely illustrative, the modules described as separate components may or may not be physically separate, and functions of the modules may be implemented in one or more of software and/or hardware when implementing the solutions in the embodiments of the present specification. Some or all of the modules may also be selected according to actual needs to achieve the effects of the solution of this embodiment.

Those skilled in the art can understand and implement the present disclosure without any creative work.

The above descriptions are only specific implementations of the embodiments of the present specification, and it should be noted that those skilled in the art can make several improvements and modifications without departing from the principle of the embodiments of the present specification, and these improvements and modifications should also be considered as the protection scope of the embodiments of the present specification.

1. A method for controlling live migration of a virtual machine, wherein the method is used for migrating device states of the virtual machine from a source physical machine to a destination physical machine, the method comprising:
performing following steps cyclically, after an initial iterative migration is performed on at least part of migration data during running of the virtual machine:
determining an amount of migration data for a next iterative migration;
estimating a migration duration of the next iterative migration based on the amount of migration data for the next iterative migration and a migration bandwidth of a current iterative migration;
in response to the migration duration being less than a predetermined time threshold, starting the next iterative migration after the virtual machine is controlled to be suspended, and completing the live migration of the virtual machine after the next iterative migration is successful; and
in response to the migration duration being greater than or equal to the time threshold, starting the next iterative migration during the running of the virtual machine, and returning to the determining the amount of migration data for the next iterative migration;
wherein the migration data of each iterative migration comprise at least the device states of the virtual machine, and the migration data of the next iterative migration are determined based on device states changed after the current iterative migration.

2. The method according to claim 1, wherein the method further comprises:
obtaining a start time of the current iterative migration;
marking the device states changed after the start time; and
determining the marked device states as the device states changed after the current iterative migration.

3. The method according to claim 1, wherein a plurality of migration channels are comprised between the source physical machine and the destination physical machine; different migration channels are configured to perform iterative migration on different migration data in the virtual machine; wherein the migration data of one of the migration channels comprise the device states of the virtual machine; and the initial iterative migration comprises initial migrations on the migration data of each migration channel;
the migration data of the next iterative migration comprise migration data which have been changed of each migration channel after the current iterative migration; and
the migration bandwidth of the current iterative migration is an average migration bandwidth of each migration channel during the current iterative migration.

4. The method according to claim 3, wherein the migration data comprise the device states and memory dirty pages of the virtual machine; both the source physical machine and the destination physical machine comprise a System On Chip (SOC) Chip and a Remote Direct Memory Access (RDMA) device; and the plurality of migration channels comprise:
a first migration channel between the SOC chip of the source physical machine and the SOC chip of the destination physical machine, configured for the iterative migration performed on the device states of the virtual machine; and
a second migration channel between the RDMA device of the source physical machine and the RDMA device of the destination physical machine, configured for the iterative migration performed on the memory dirty pages of the virtual machine.

5. The method according to claim 4, wherein the method further comprises:
for each iterative migration, controlling the SOC chip of the source physical machine to issue device states to be migrated during the iterative migration to the SOC chip of the destination physical machine through the first migration channel; and
for each iterative migration, controlling the SOC chip of the source physical machine to send a first storage address of the memory dirty pages to be migrated in the source physical machine during the iterative migration to the SOC chip of the destination physical machine, so that the memory dirty pages stored in the first storage address are pulled by the RDMA device of the destination physical machine through the second migration channel.

6. The method according to claim 4, wherein the method further comprises:
for each iterative migration, controlling the SOC chip of the source physical machine to issue device states to be migrated during the iterative migration to the SOC chip of the destination physical machine through the first migration channel; and
for each iterative migration, after the SOC chip of the source physical machine receives a second storage address sent by the SOC chip of the destination physical machine, controlling the RDMA device of the source physical machine to write memory dirty pages to be migrated during the iterative migration into the second storage address through the second migration channel.

7. The method according to claim 3, wherein the average migration bandwidth is determined based on a total amount of migration data of each migration channel during the current iterative migration and a total migration duration of each migration channel during the current iterative migration; wherein:
in response to iterative migrations in each migration channel being performed in parallel, the total migration duration of each migration channel during the current iterative migration is determined based on a maximum value of migration durations of each migration channel during the current iterative migration; or
in response to the iterative migrations in each migration channel being performed in series, the total migration duration of each migration channel during the current iterative migration is determined based on a sum of the migration durations of each migration channel during the current iterative migration.

8. The method according to claim 1, wherein the method further comprises:
obtaining migration durations of a plurality of iterative migrations; and
determining whether a termination condition for the live migration is satisfied based on the migration durations of the plurality of iterative migrations.

9. The method according to claim 8, wherein the determining whether the termination condition for the live migration is satisfied based on the migration durations of the plurality of iterative migrations comprises:
in response to a determination that the migration durations of each iterative migration in the plurality of iterative migrations within a predetermined time period are all greater than or equal to the time threshold, determining that the termination condition for the live migration is satisfied.

10. The method according to claim 8, wherein the method further comprises:
in response to a determination that the termination condition for the live migration is satisfied, the iterative migration is terminated.

11. (canceled)

12. A non-transitory computer-readable storage medium, having computer programs stored thereon, wherein the programs are executed by a processor to implement the method according to claim 1.

13. A computer device, comprising a non-transitory storage, a processor, and computer programs stored in the non-transitory storage and executable on the processor, wherein the programs are executed by the processor to perform operations for controlling live migration of a virtual machine, so as to migrate device states of the virtual machine from a source physical machine to a destination physical machine, the operations comprising:
performing following steps cyclically, after an initial iterative migration is performed on at least part of migration data during running of the virtual machine:
determining an amount of migration data for a next iterative migration;
estimating a migration duration of the next iterative migration based on the amount of migration data for the next iterative migration and a migration bandwidth of a current iterative migration;
in response to the migration duration being less than a predetermined time threshold, starting the next iterative migration after the virtual machine is controlled to be suspended, and completing the live migration of the virtual machine after the next iterative migration is successful; and
in response to the migration duration being greater than or equal to the time threshold, starting the next iterative migration during the running of the virtual machine, and returning to the determining the amount of migration data for the next iterative migration;
wherein the migration data of each iterative migration comprise at least the device states of the virtual machine, and the migration data of the next iterative migration are determined based on device states changed after the current iterative migration.

14. The computer device according to claim 13, wherein the operations further comprise:
obtaining a start time of the current iterative migration;
marking the device states changed after the start time; and
determining the marked device states as the device states changed after the current iterative migration.

15. The computer device according to claim 13, wherein a plurality of migration channels are comprised between the source physical machine and the destination physical machine; different migration channels are configured to perform iterative migration on different migration data in the virtual machine; wherein the migration data of one of the migration channels comprise the device states of the virtual machine; and the initial iterative migration comprises initial migrations on the migration data of each migration channel;
the migration data of the next iterative migration comprise migration data which have been changed of each migration channel after the current iterative migration; and
the migration bandwidth of the current iterative migration is an average migration bandwidth of each migration channel during the current iterative migration.

16. The computer device according to claim 15, wherein the migration data comprise the device states and memory dirty pages of the virtual machine; both the source physical machine and the destination physical machine comprise a System On Chip (SOC) Chip and a Remote Direct Memory Access (RDMA) device; and the plurality of migration channels comprise:
a first migration channel between the SOC chip of the source physical machine and the SOC chip of the destination physical machine, configured for the iterative migration performed on the device states of the virtual machine; and
a second migration channel between the RDMA device of the source physical machine and the RDMA device of the destination physical machine, configured for the iterative migration performed on the memory dirty pages of the virtual machine.

17. The computer device according to claim 16, wherein the operations further comprise:
for each iterative migration, controlling the SOC chip of the source physical machine to issue device states to be migrated during the iterative migration to the SOC chip of the destination physical machine through the first migration channel; and
for each iterative migration, controlling the SOC chip of the source physical machine to send a first storage address of the memory dirty pages to be migrated in the source physical machine during the iterative migration to the SOC chip of the destination physical machine, so that the memory dirty pages stored in the first storage address are pulled by the RDMA device of the destination physical machine through the second migration channel; or
the operations further comprise:
for each iterative migration, controlling the SOC chip of the source physical machine to issue device states to be migrated during the iterative migration to the SOC chip of the destination physical machine through the first migration channel; and
for each iterative migration, after the SOC chip of the source physical machine receives a second storage address sent by the SOC chip of the destination physical machine, controlling the RDMA device of the source physical machine to write memory dirty pages to be migrated during the iterative migration into the second storage address through the second migration channel.

18. The computer device according to claim 15, wherein the average migration bandwidth is determined based on a total amount of migration data of each migration channel during the current iterative migration and a total migration duration of each migration channel during the current iterative migration; wherein:
in response to iterative migrations in each migration channel being performed in parallel, the total migration duration of each migration channel during the current iterative migration is determined based on a maximum value of migration durations of each migration channel during the current iterative migration; or
in response to the iterative migrations in each migration channel being performed in series, the total migration duration of each migration channel during the current iterative migration is determined based on a sum of the migration durations of each migration channel during the current iterative migration.

19. The computer device according to claim 13, wherein the operations further comprise:
obtaining migration durations of a plurality of iterative migrations; and
determining whether a termination condition for the live migration is satisfied based on the migration durations of the plurality of iterative migrations;
wherein the determining whether the termination condition for the live migration is satisfied based on the migration durations of the plurality of iterative migrations comprises:
in response to a determination that the migration durations of each iterative migration in the plurality of iterative migrations within a predetermined time period are all greater than or equal to the time threshold, determining that the termination condition for the live migration is satisfied.

20. The computer device according to claim 19, wherein the operations further comprise:
in response to a determination that the termination condition for the live migration is satisfied, the iterative migration is terminated.

21. A method for controlling live migration of a virtual machine, wherein the method is used for migrating device states and memory dirty pages of the virtual machine from a source physical machine to a destination physical machine, wherein both the source physical machine and the destination physical machine comprise a System On Chip (SOC) chip and a Remote Direct Memory Access (RDMA) device; the method comprises:
controlling the SOC chip of the source physical machine to migrate the device states of the virtual machine to the SOC chip of the destination physical machine; and
controlling the RDMA device of the source physical machine to migrate the memory dirty pages of the virtual machine to the RDMA device of the destination physical machine; wherein a migration process of the device states and a migration process of the memory dirty pages are performed in parallel.
